(19) United States
(12) Patent Application Publication
(10) Pub. No.: US 2006/0253472 A1
(43) Pub. Date: Nov. 9, 2006

(54) System, method, and service for automatically determining an initial sizing of a hardware configuration for a database system running a business intelligence workload

(76) Inventors: Theodore Jeremy Wasserman, Palo Alto, CA (US); Haider Rizvi, Richmond Hill (CA); Thomas Patrick Martin, Kingston (CA)

Correspondence Address: SAMUEL A. KASSATLY LAW OFFICE, 20690 VIEW OAKS WAY, SAN JOSE, CA, 95120, US

(21) Appl. No.: 11/122,169

(22) Filed: May 3, 2005

(51) Int. Cl. G06F 7/00

(52) U.S. Cl. 707/100

(57) ABSTRACT

A business intelligence hardware sizing system automatically determines an initial hardware configuration for a database system running a business intelligence workload. The business intelligence hardware sizing system provides a structured approach for determining an initial configuration of a database tier of a business intelligence application. The business intelligence hardware sizing system comprises a formal model of a database system sizing process and an easy-to-use software tool to support the approach.

### CROSS-REFERENCE TO RELATED APPLICATION

The present application is related to co-pending U.S. patent application, titled “System, Service, And Method For Characterizing A Business Intelligence Workload For Sizing A New Database System Hardware Configuration,” Ser. No. ______, filed concurrently herewith, which is assigned to the same assignee as the present invention, and which is incorporated herein by reference.

### FIELD OF THE INVENTION

The present invention generally relates to business intelligence or data warehouse systems, and more specifically to a method for determining an initial sizing of a database system hardware configuration required to support a new business intelligence or data warehouse system. It is assumed that the new system has no available detailed performance measurements or environment characteristics yet.

### BACKGROUND OF THE INVENTION

Database systems play a vital role in the information technology infrastructure of a business or corporation. In particular, databases used for data warehousing and business intelligence applications are becoming an important segment of the total database market. Business intelligence systems transform raw data into useful information. Common applications of business intelligence systems are, for example, fraud detection, risk analysis, market segmentation, and profitability analysis.

In a business intelligence system, data is extracted from heterogeneous operational databases and external data sources, then cleansed, transformed, and loaded into a large data warehouse or data mart storage areas. Data warehouses are subject-oriented, integrated, and time-varied collections of data used primarily for making decisions. Data marts are departmentalized subsets of the data warehouse focusing on selected subjects, rather than the entire enterprise data.

Data is stored and managed by one or more data warehouse servers that provide data access to front end tools for querying, reporting, analysis, and mining. Specialized online analytical processing (OLAP) servers may also be used to construct multidimensional views of the data, where aggregation and summarization operations such as ROLLUP and SLICE-AND-DICE can be performed.

Another component of the business intelligence architecture comprises facilities for monitoring and administration. These processes preserve the integrity, security, and relevancy of the data. Business intelligence systems make extensive use of meta-data, for instance, to keep track of information such as where the source data feeds are, when the data was last updated, who accesses the data, and the access patterns of the data. Meta data must be managed and kept up-to-date.

Two common, yet distinct workloads are therefore associated with a business intelligence application. The back-end workload, typically referred to as the batch or extract-transform-load (ETL) workload (further referenced herein as a batch/ETL workload), is responsible for loading production data into the data warehouse and keeping the warehouse up-to-date. The front-end workload, typically referenced as the query or online/production workload, is the workload generated by users submitting business queries to the system.

Computer capacity planning is the process of analyzing and projecting an existing workload to determine the type of hardware resources needed to meet future demand and to predict when system saturation occurs. The capacity planning process assumes the existence of a stable and well-studied workload with detailed performance measurements. The process can be long and challenging, depending on the size and complexity of the application, the quality and quantity of information available, as well as the approaches and tools employed.

Many of the approaches and tools used for capacity planning were developed in the late-1970s and early-1980s when mainframe computers were the dominant computing platform. Mainframes were very expensive; therefore it was critical to perform detailed planning and analysis before a particular model was purchased. A variety of tools were created to help a planner with this task, including tools for performance monitoring, workload forecasting, performance simulation, and design/configuration advice.

As mainframe architectures slowly gave way to client-server, and more recently, n-tier architectures, the focus on planning was not as systematic. This may be partly attributed to financial factors; namely the declining cost and improving performance of computer hardware. The cost of a cluster of inexpensive server machines networked together became substantially less than that of a mainframe. Fixing configuration errors resulting from poor planning would cost in the thousands of dollars for n-tier architectures versus millions of dollars for mainframes. The additional cost to perform detailed planning analysis often exceeded the costs to correct configuration errors, thus complete planning studies were relatively unattractive.

The complexity of modeling performance in n-tier architectures also makes planning more difficult. Traditional methods used for mainframes are not directly transferable to n-tier architectures. In the mainframe domain, components such as processors, disks, and memory share similar designs and characteristics; however, this is not the case in n-tier environments. The proliferation of competing and sophisticated processor, disk, memory, and network technologies makes creating generic performance models very difficult.

The resource demands of modern applications are also more complex and demanding in nature than in the past, making their performance less predictable. The popularity and commercialization of the Internet and World Wide Web fostered the demand for newer and richer data such as graphics, audio, video, and XML. Whereas this data was once stored for archival purposes only, companies have now started analyzing it with specialized data analysis applications to discover new information about their businesses and customers. This places additional resource burdens on systems in addition to the traditional transaction processing workloads being handled.

Time and business pressures also make detailed capacity planning studies infeasible. In today's on-demand business environment, customers expect answers in a timely fashion, often in minutes or hours. A day or week is often a critical amount of time for completing a hardware sale. This implies that any capacity planning analysis needs to be performed quickly while maintaining a high degree of accuracy.

Computer system sizing involves estimating the hardware resources needed to support a new workload that has not yet been run in a production environment. Sizing assumes that little system environment information or performance measurements are available, thus a sizing expert relies on extrapolations from similar workloads, industry benchmarks, informal industry guidelines, and hardware performance guidelines to determine the type and quantity of required resources. Determining the hardware configuration required can be a complicated task because of the wide variety of processor, disk, network, and memory technologies available. Further, determining the quantity of each hardware resource needed and predicting how the different hardware components interact under a specific workload are non-trivial tasks.

A sizing process for a database system results in an initial estimate of a hardware configuration that satisfies the performance demands, cost constraints, and functional requirements of the application and its workload. Typically, detailed information about the application and its workload is not available. Currently, using an ad-hoc approach, sizing experts typically find published performance results for a similar workload with similar performance requirements. The sizing experts extrapolate from these performance results using a combination of personal experience, informal industry guidelines or “rules-of-thumb”, and published performance relationships between different types of hardware.

The result of the sizing process is an initial estimate of a hardware configuration (processor, disk, and memory) needed to meet the resource demands of the expected workload and size of database. Customers expect a cost-efficient and effective hardware solution that meets the performance requirements of their application while offering the maneuverability to accommodate future expansion. There is generally no opportunity for experts to validate their hardware recommendations because of financial and time constraints. Sizing also currently involves significant manual effort to complete.

Most capacity planning and sizing methods are geared towards traditional transaction processing workloads. Business intelligence workloads have very different characteristics than their transaction-processing counterparts. These differences comprise a greater emphasis on summarized and consolidated data (versus a focus on individual records), and a very large database size. These differences further comprise queries that are heterogeneous, complex and ad-hoc in nature, and vary greatly in elapsed time. Queries in business intelligence workloads often touch millions of records and may perform many table joins, sorts, and aggregations. Business intelligence queries sometimes produce very large results sets, requiring a lot of concurrent I/O.

Conventional approaches to sizing and capacity planning for business intelligence workloads focus on performance evaluation, workload characterization, and workload prediction. While the conventional approaches to capacity planning and sizing processes have some activities in common, they have different objectives and methodologies. The majority of conventional capacity planning studies and approaches assume that detailed performance measurements from a production environment are available to build models of system performance. Sizing is performed with high-level and incomplete information.

Although current techniques have proven to be useful, it would be desirable to present additional improvements. Conventional techniques for sizing a database system are manually performed by sizing experts. Furthermore, conventional techniques assume that little system environment information or performance measurements are available, thus a sizing expert relies on extrapolations from similar workloads based on personal experience, industry benchmarks, informal industry guidelines, and hardware performance guidelines to determine the type and quantity of required resources. There are currently no available and automatic methods for determining an initial sizing for a database system running a business intelligence workload.

What is therefore needed is a system, a service, a computer program product, and an associated method for automatically determining an initial sizing of a database system running a business intelligence workload. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for automatically determining an initial sizing of a hardware configuration for a database system running business intelligence workload. The present system provides a structured approach for selecting an initial size of the database tier of a business intelligence application. The present system comprises a formal model of a database system sizing process and an easy-to-use software tool as the interface for a user. The present system arrives at an initial estimate of what hardware resources are required for a business intelligence system.

The present system uses a combination of informal industry guidelines (rules of thumb) and extrapolations from collected performance data to determine the type and quantity of hardware resources needed. Online/production and batch/ETL workloads of a customer are characterized in terms of parameters such as, processing power, throughput, and I/Os per second (further referenced herein as IOPS). These parameters are used to determine processor and disk requirements. Memory and storage requirements are determined using common informal industry guidelines.

Traditional capacity planning is geared towards estimating the future computing resource requirements of an existing workload. In contrast, the present system estimates the computing resources required to support a new workload that has not yet been run in a production environment. Since it is assumed that there are few production measurements available for a new workload, estimations are made that rely on assumptions, extrapolations from similar workloads, industry benchmarks, and informal industry guidelines.

The present system comprises an input collection module, a verification module, a workload requirement module, a workload selection module, a hardware configuration module, and a ranking module. The input collection module receives input describing the anticipated workload of the business intelligence system. The workload requirement module projects resource requirements for the business intelligence system from a similar, well-studied workload. The workload selection module selects possible workload configurations from one or more scenarios. The hardware configuration module selects possible system hardware configurations that meet the projected resource requirements for the workload selected by the workload selection module. The ranking module ranks the possible system hardware configurations according to a predetermined ranking criterion. The present system displays the results to a user or sizing expert.

The present invention may be embodied in a utility program such as a business intelligence hardware sizing utility program. The present invention provides means for the user to specify a set of parameters describing the anticipated workload characteristics of a business intelligence system, workload operating scenarios, and ranking criteria. The present system further provides means for the user to invoke the business intelligence hardware sizing utility program to automatically determine workload resource requirements, size a workload requirement according to the workload operating scenario, determine potential hardware configurations for the business intelligence system, and rank the hardware configurations according to the ranking criteria.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a business intelligence hardware sizing system of the present invention can be used;

FIG. 2 is a block diagram of the high-level architecture of the business intelligence hardware sizing system of FIG. 1;

FIG. 3 is a process flow chart illustrating a method of operation of the business intelligence hardware sizing system of FIGS. 1 and 2;

FIG. 4 is a process flow chart illustrating a method of operation of the business intelligence hardware sizing system of FIGS. 1 and 2 in verifying input data;

FIG. 5 is comprised of FIGS. 5A and 5B and represents a process flow chart illustrating a method of operation of the business intelligence hardware sizing system of FIGS. 1 and 2 in determining workload-sizing requirements;

FIG. 6 is a process flow chart illustrating a method of operation of the business intelligence hardware sizing system of FIGS. 1 and 2 in sizing a workload requirement according to a selected workload scenario;

FIG. 7 is a process flow chart illustrating a method of operation of the business intelligence hardware sizing system of FIGS. 1 and 2 in determining one or more hardware configurations for a business intelligence hardware configuration; and

FIG. 8 is a process flow chart illustrating a method of operation of the business intelligence hardware sizing system of FIGS. 1 and 2 in ranking the hardware configurations according to a predetermined criterion.

### DETAILED DESCRIPTION OF PREFERRED EMBODIMENTS

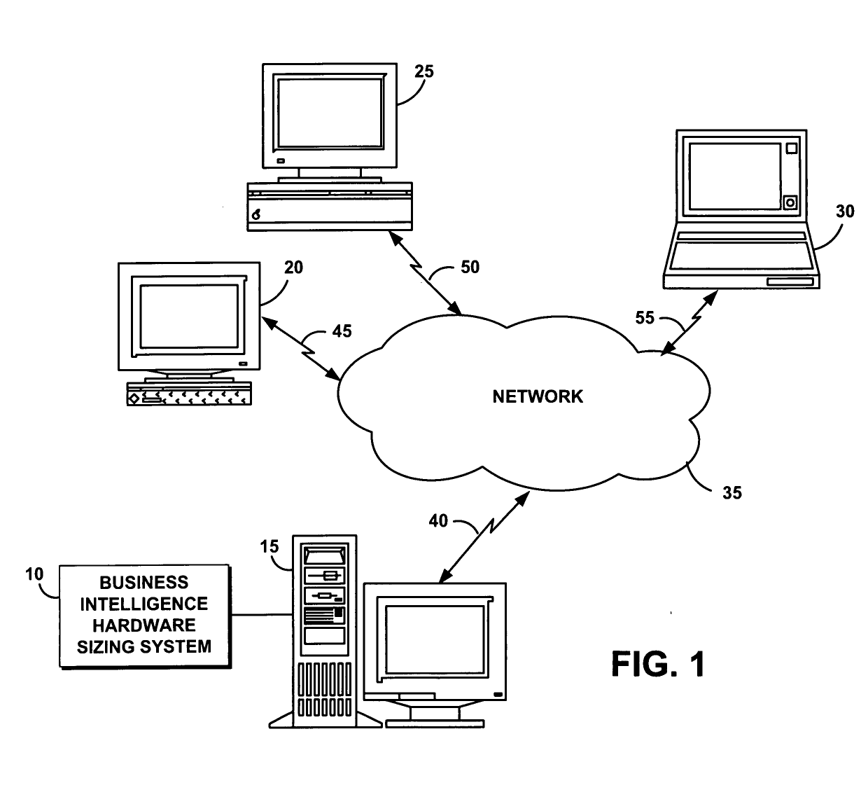

FIG. 1 portrays an exemplary overall environment in which a system and associated method for automatically determining an initial sizing of a database system running a business intelligence workload according to the present invention may be used. System 10 comprises a software programming code or a computer program product that is typically embedded within, or installed on a host server 15. Alternatively, system 10 can be saved on a suitable storage medium such as a diskette, a CD, a hard drive, or like devices.

Users, such as remote Internet users, are represented by a variety of computers such as computers 20, 25, 30, and can access the host server 15 through a network 35. Computers 20, 25, 30 each comprise software that allows the user to interface securely with the host server 15. The host server 15 is connected to network 35 via a communications link 40 such as a telephone, cable, or satellite link. Computers 20, 25, 30, can be connected to network 35 via communications links 45, 50, 55, respectively. While system 10 is described in terms of network 35, computers 20, 25, 30 may also access system 10 locally rather than remotely. Computers 20, 25, 30 may access system 10 either manually, or automatically through the use of an application.

Users provide input to system 10 for determination of an initial sizing of the database tier of a business intelligence system. System 10 provides to the users one or more potential hardware configurations that will meet the workload requirements of the business intelligence system.

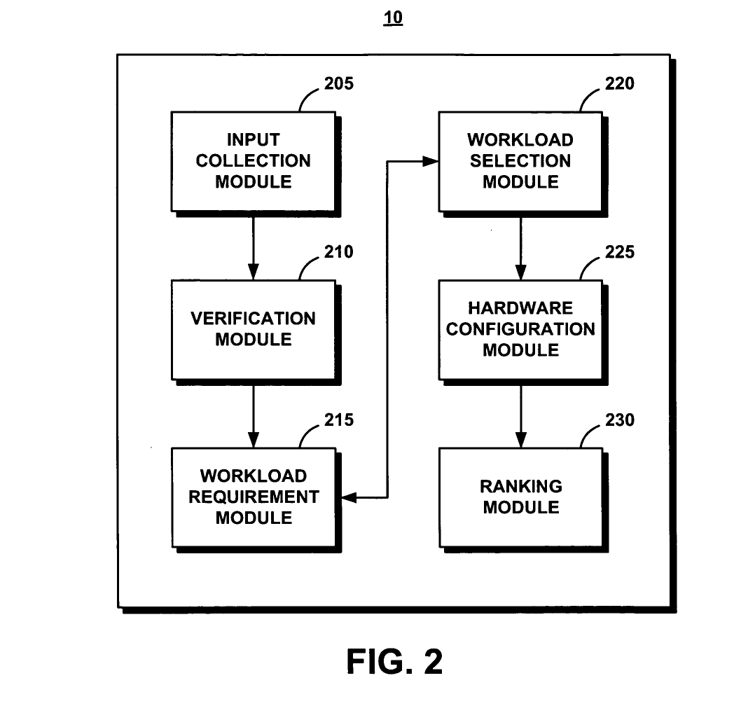

FIG. 2 illustrates a high-level hierarchy of system 10. System 10 comprises an input collection module 205, a verification module 210, a workload requirement module 215, a workload selection module 220, a hardware configuration module 225, and a ranking module 230.

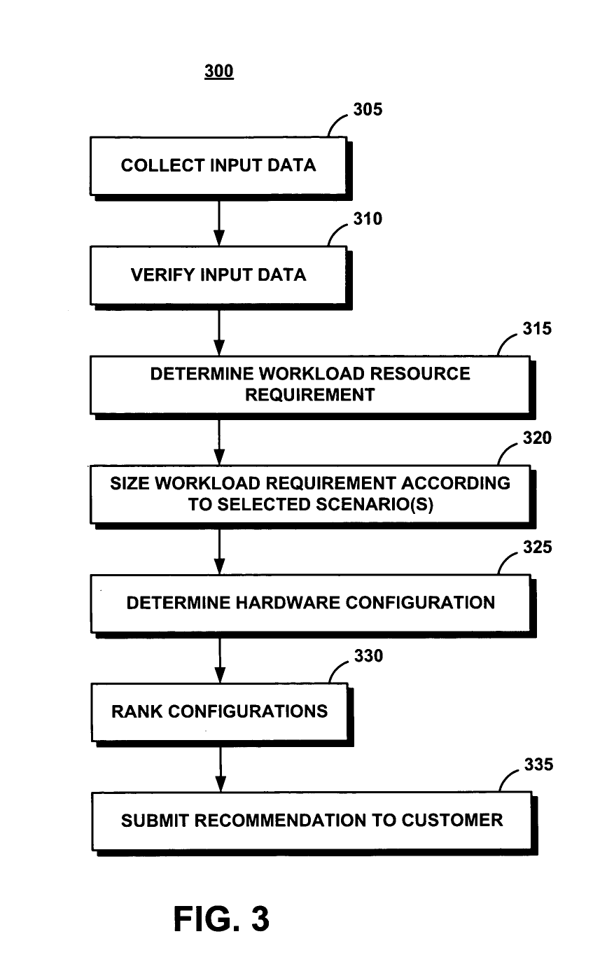

FIG. 3 illustrates a method 300 of system 10 in generating one or more initial sizings for a database system running a business intelligence workload. While method 300 is general to most relational database management systems and workloads, implementation of method 300 depends on specific details of a described workload or database management system.

The input collection module 205 collects input data for use in determining an initial sizing of a database system running a business intelligence workload (step 305). Collecting input data comprises collecting information about a target application such as a database management system running a business intelligence workload. Collecting input data further comprises collecting information about the business intelligence workload. Methods of collecting information comprise, for example, providing a questionnaire to a customer to complete or interviewing the customer. The customer may access the customer questionnaire, for example, over a network as illustrated in FIG. 1.

If precise information about the target application or the business intelligence workload is not readily available, assumptions and educated guesses are made. The collected information is based on the peak business intelligence workload expected. Common types of high-level information collected by the input collection module comprises the number of concurrent and active users, the data being stored in terms of a database size and actively referenced data, different workloads processed by the target application and performance goals of the workloads, specific time windows required by the different workloads, and additional information such as high availability requirements, backup requirements, or specific features required by the customer.

The verification module 210 verifies the collected input data (step 310). When information is unavailable, assumptions and estimations are made. Sometimes, estimations may contradict known/measured data or other assumptions. The verification module 210 examines the collected information for inconsistencies automatically or manually by a sizing expert. Any inconsistencies found in the collected data are corrected.

The workload requirement module 215 determines workload resource requirements (step 315). The workload requirement module 215 analyzes each type of workload and service demand for each workload class. The workload requirement module 215 determines specific resource demands from this analysis. Resource demands are commonly stated in terms of specific entities, such as processor, disk, and memory units required. Resource demands can be derived by synthetic calculations based on informal guidelines or logical formulae. Resource demands are further derived from extrapolations and projections using existing performance data and informal industry guidelines.

The workload selection module 220 sizes the workload requirement according to the selected scenario (step 320). Once the demands of the different workload classes have been determined, the workload requirement module 215 determines the overall resource demands required by the business intelligence system by factoring in a relative mix of each of the different workload classes during the peak system usage period. If necessary, the workload requirement module 215 adjusts aggregated resource units to maintain a desired balance between the different resource units. Balancing ensures that the calculated quantity of one resource is not out of proportion with the calculated quantity of another resource. Balancing factors used are based on informal industry guidelines and prior benchmarking experience.

The business intelligence system is balanced so that all of its resources are working in concert to allow the optimal amount of workload through the system in order to meet specific objectives. For example, to fully utilize all the available disks in a system, a minimum processor capacity is required to drive the disk processing. After balancing resource unit demands, the workload requirement module 215 adds additional contingency units to deal with occasional spikes in system usage and to reserve extra capacity for the future. The number of contingency units to be added is customizable.

The hardware configuration module 225 determines hardware configurations for the database tier of the business intelligence system by providing a list of system models and configurations that meets the workload demands of the business intelligence system (step 325). Usually, more than one configuration meets the performance requirements of the application. Therefore, the hardware configuration module 225 uses other factors such as model preference, operating system preference, high availability features, and expandability to restrict the size and content of the final list of configuration recommendations.

The ranking module 230 ranks the relevant configurations according a predetermined ranking criterion (step 330). An example of a ranking criterion is to rank configurations that most closely meet the calculated workload resource demands ahead of those that do not. Other examples of a ranking criterion include ranking configurations of the business intelligence system by cost, price per performance, system upgradeability, serviceability, compatibility, reliability, etc.

The output of system 10 is a formal hardware configuration recommendation for the database tier of the business intelligence system. This formal hardware recommendation comprises information about the server model, disk subsystem, memory, and storage required. For servers, typical recommendations comprise the model number/series, number of server nodes (cluster size), number/type/speed of processors, and memory per node. For disk subsystems, typical recommendations comprise the model number/series, the number of disk subsystem units required, and the amount of raw storage required.

Table 1 illustrates exemplary input data collected by the input collection module 205 for an online/production workload. Categories for which input is collected for the online/production workload comprise users, data, query performance requirements, workload mix, and other.

TABLE 1
Exemplary input data collected by the input collection module 205 for
an online/production workload.
Users

| | |
|---|---|
| Number of concurrent users | The number of users that are connected to the |
| | business intelligence system during the peak |
| | period. Users may or may not be submitting |
| | queries to the business intelligence system. |
| Number of active users | The number of users actively submitting queries |
| | to the business intelligence system during the |
| | peak period. Generally, the number of active |
| | users is substantially less than the total number |
| | of potential users of the business intelligence |
| | system. |

Data

| | |
|---|---|
| Raw size of data | The size of the data, in gigabytes, before being |
| (GB) | loaded into the database. This is equivalent to |
| | size of the data if it were to reside in flat files. |
| | This is not to be confused with the size of the |
| | data once it is loaded into a DBMS. |
| Percentage of active data | The percentage of raw data that is active. A |
| | value of 100% means that the majority of |
| | queries reference the entire database. In many |
| | cases, this is not true. For example, an online |
| | retailer may store 3 years of customer purchase |
| | data to meet audit requirements. However, most |
| | users are primarily interested in the last 12 |
| | months of data. |
| External storage required | The amount of storage, in gigabytes, needed by |
| (GB) | other parts of the business intelligence system, |
| | including the application itself, the operating |
| | system, and additional temporary/staging space. |
| Log storage required | The amount of storage, in gigabytes, required by |
| (GB) | the transaction log of the DBMS. |

Query Performance Requirements

| | |
|---|---|
| Trivial Complexity Query | The average response time, in seconds, of trivial |
| Response Time (seconds) | complexity queries. |
| Simple Complexity Query | The average response time, in seconds, of |
| Response Time | simple complexity queries. |
| (seconds) | |
| Medium Complexity Query | The average response time, in seconds, of |
| Response Time | medium complexity queries. |
| (seconds) | |
| Large Complexity Query | The average response time, in seconds, of large |
| Response Time (seconds) | complexity queries. |

Workload Mix

| | |
|---|---|
| Trivial Complexity Query Mix | The percentage mix of trivial complexity queries |
| (%) | in the workload during the peak period. |
| Simple Complexity Query | The percentage mix of simple complexity |
| Mix | queries in the workload during the peak period. |
| (%) | |
| Medium Complexity Query | The percentage mix of medium complexity |
| Mix | queries in the workload during the peak period. |
| (%) | |
| Large Complexity Query Mix | The percentage mix of large complexity queries |
| (%) | in the workload during the peak period. |

Other

| | |
|---|---|
| Contingency Desired | The amount of additional contingency room to |
| (%) | reserver after calculating the workload resource |
| | requirements. This value also applies to the batch/ETL |
| | workload. |

Table 2 illustrates exemplary input data collected by the input collection module 205 for a batch/ETL workload. Categories for which input is collected for the batch/ETL workload comprise time window, extract-transform, load, and other.

Time Window

| | |
|---|---|
| Overall time window | Typical batch/ETL workloads run during a fixed |
| (Hours) | time window, such as overnight, or during non- |
| | business hours. This parameter specifies the |
| | time window in which the batch/ETL workload is |
| | to be completed. |
| Overlaps with online | If the batch/ETL workload overlaps with the |
| workload? | online/production workload, the sizing should be |
| (YES/NO) | based on the aggregate resource demands of |
| | both workloads. |

Extract-Transform Phases

| | |
|---|---|
| Input volume | The total volume of data, in megabytes, that is |
| (MB) | extracted from the operational/production |
| | databases and is transformed or normalized |
| | before being loaded into the data warehouse. |
| Input row size | The average size of a row, in bytes, that is |
| (Bytes) | extracted from the operational/production |
| | database(s). |
| Output row size | The average size of a row, in bytes, that is |
| (Bytes) | loaded into the data warehouse. |
| Transform complexity | A constant factor reflecting the relative amount |
| (1.0-5.0) | of transformation processing that is performed. |
| | Some batch/ETL processes are more intensive |
| | than others. This parameter is used to reflect the |
| | degree of transforming/processing complexity (a |
| | lower number means a lower complexity). |

Load Phase

| | |
|---|---|
| Average number of | The average number of secondary indexes that |
| secondary indexes | are maintained on the various tables affects the |
| | performance of loading data into the data |
| | warehouse. A secondary index is defined as a |
| | non-key index used to improve query |
| | performance. When tables are updated with new |
| | data, indexes based on those tables are also |
| | updated. The number and types of secondary |
| | indexes used are dependent on the nature of |
| | queries being submitted to the business |
| | intelligence system. If this parameter is not |
| | known, a default value of 1 or 2 is suggested. |

Other

| | |
|---|---|
| Contingency Desired | This parameter is the same as the one described |
| (%) | for online/production workloads. This value also |
| | applies to the online/production workload. |

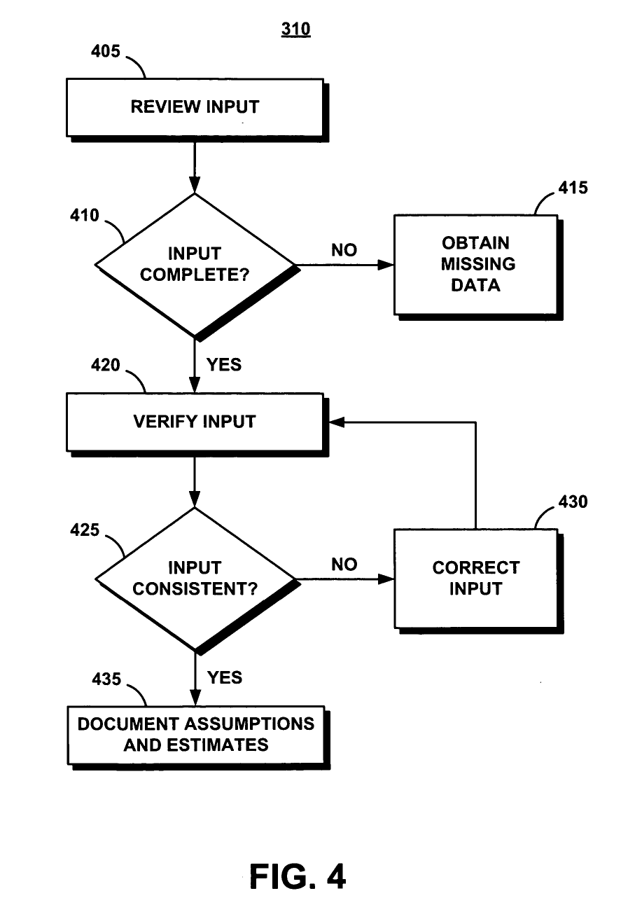

FIG. 4 illustrates in more detail a method of the verification module 210 in performing step 310. The verification module 210 automatically reviews the input information provided by the customer for completeness (step 405). In one embodiment, a sizing expert manually reviews the input. The verification module 210 determines if the input information is complete (decision step 410). If the input is not complete, missing data is obtained (step 415). Missing data may be obtained automatically by issuing, for example, an e-mail to the client. In one embodiment, a sizing expert obtains missing data manually through a contact with the customer. Unknown values may be estimated, if necessary.

Once the input is complete, the verification module 210 verifies the input to ensure that the values in the input are within realistic ranges and to ensure that the values in the input do not contradict each other (step 420). The verification module determines whether the input information is consistent and reasonable (decision step 425). If discrepancies arise, the input is corrected (step 430). Input can be corrected by interacting with the customer either automatically or manually, as before. Once all values are deemed to be consistent and accurate, the verification module 210 documents any assumptions or estimates that were made to avoid future misunderstandings (step 435).

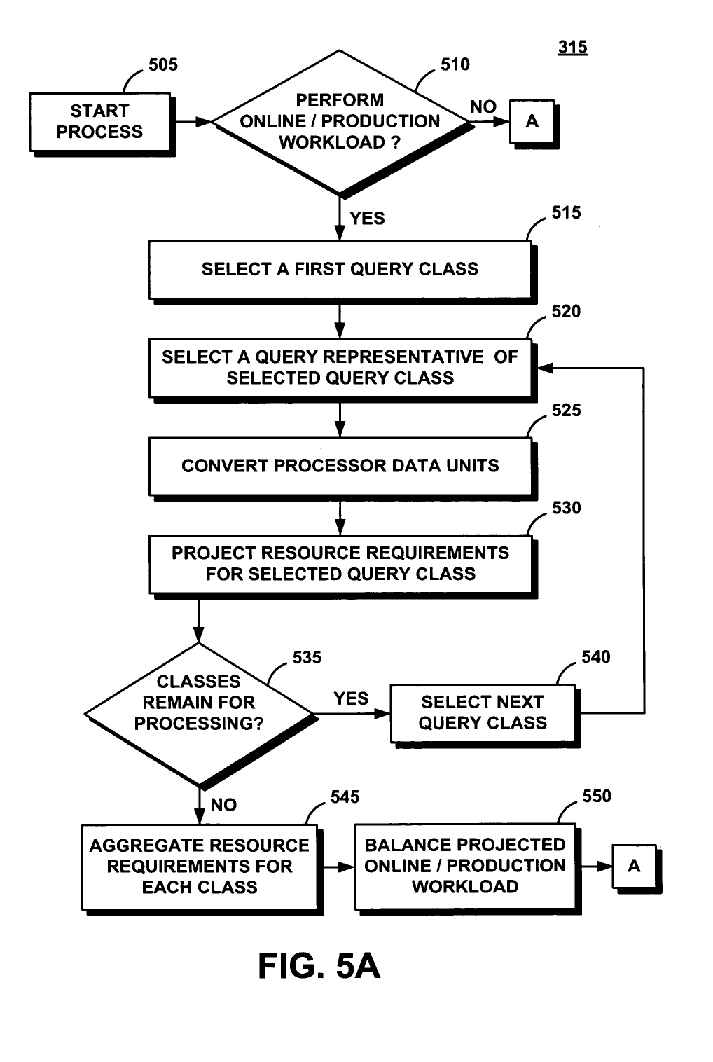

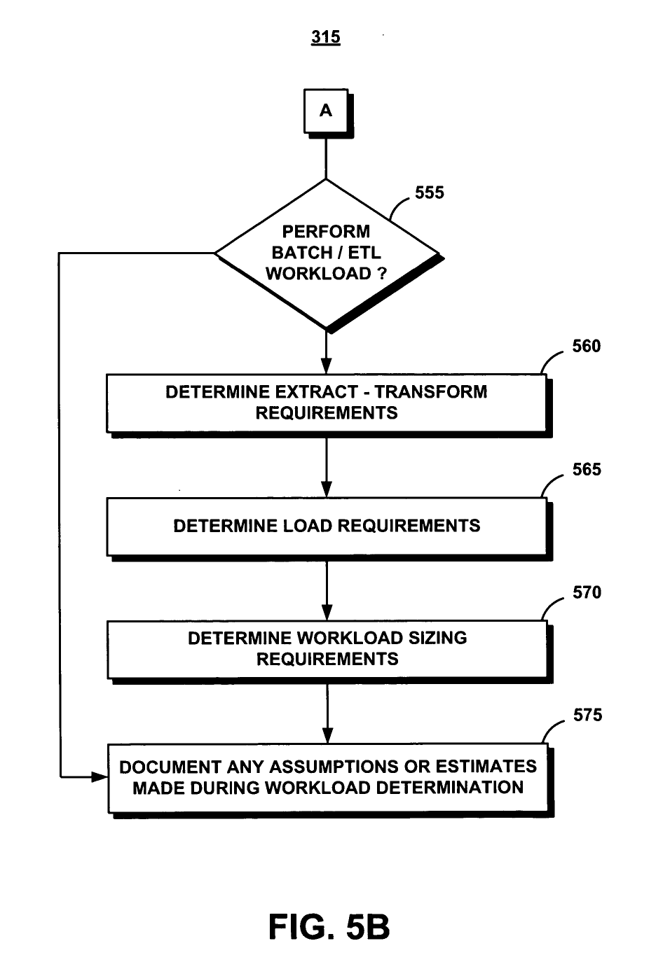

FIG. 5 (FIGS. 5A, 5B) illustrates in more detail a method of the workload requirement module 215 in performing step 315, determining workload resource requirements. Business intelligence systems typically process two distinct workload types, the online/production workload and the batch/ETL workload. The workload requirement module 215 starts the workload requirement determination process (step 505). The workload requirement module 215 determines whether to perform analysis for an online/production workload (decision step 510).

If the business intelligence system comprises an online/production workload, the workload requirement module 215 selects a first query class for analysis (step 515). A model generated by system 10 of the business intelligence workload is constructed out of descriptive parameters and is described by a set of mean parameter values that reproduce the resource usage of an actual workload. System 10 utilizes classes of business intelligence queries, by taking queries from a well-studied or industry benchmark business intelligence workload, and partitioning them into a few general classes based on their resource usage, as determined by any known or available workload characterization techniques. Each class comprises up to b queries that are similar to each other based on resource usage.

The workload requirement module 215 selects a representative query, Q_{A}, to serve as a basis for sizing queries of a selected query class, class C, in the workload of the business intelligence system (step 520). The representative query, Q_{A}, is selected based on similarity to queries of class C in the workload of the business intelligence system being sized. Up to n different measurements might exist for Q_{A}, arising from running Q_{A} on different systems and/or benchmarks.

The workload requirement module 215 converts processor units to a predetermined standard unit of processing power (step 525), which in our case is based on the Standard Performance Evaluation Council's (SPEC) CPU2000 benchmark. More specifically, we determine the peak number of SPECint2000 units used in the processing of Q_{A}. This allows system 10 to make use of a known, empirical measurement of processor performance.

The workload requirement module 215 projects new resource requirements (step 530). The workload requirement module 215 computes a ratio, m, between the observed response time of Q_{A} and the specified response time goal for class C, for each of the n Q_{A} measurements. The workload requirement module 215 further considers the relative difference in database size used to determine performance characteristics of the selected query Q_{A} measurement and the size of the database in the business intelligence system being sized. A relative database size ratio d is calculated as the ratio between the amount of actively referenced data in the new environment and the database size at which query Q_{A} data measurement was run. The product of m and d is herein referenced as a resource multiplier. The resource multiplier effectively projects what fraction of greater or fewer resources may be needed to run the query under different performance goals and environment conditions in the business intelligence system being sized.

Once m is determined for each of the Q_{A} measurements, the workload requirement module scales the performance parameters of each Q_{A} by its respective m to obtain projections of the resources required for processing the query in the business intelligence system being sized. If the new response time goal is more aggressive or the database size of the business intelligence system being sized is larger than that used by Q_{A}, more resources are required to complete the task. If the new response time goal is less aggressive or the new database size is smaller than that used by Q_{A}, fewer resources are required to complete the task.

The workload requirement module 215 scales each of the n Q_{A} data measurements by their respective resource multipliers, resulting in n projections for each of the different parameter units used to describe performance of the workload. The workload requirement module 215 selects one of the n projections, for each of the respective performance measurements, to represent the class resource requirements of the new workload. The workload requirement module selects the median projection because the median projection is not influenced by extreme values for the projection and the median projection is a compromise between a conservative and an optimistic estimate of the projection. In one embodiment, the workload requirement module may select a projection such as, for example, the most conservative projection, the most optimistic projection, an average projection, or a weighted average of the projections.

The workload requirement module 215 determines total resource requirements for a query class C given its concurrency level in the workload, yielding the projected new resource requirements for the selected query class. The concurrency level is the approximate number of query Cs being processed concurrently by the system during the peak period. The concurrency level is determined by multiplying the number of active users submitting queries by the percentage mix of C in the workload. The total, unbalanced resource requirements for C can then be calculated by multiplying the Class resource requirement measurements previously selected by the appropriate concurrency level.

The workload requirement module 215 determines whether additional classes remain for processing (decision step 535). If yes, the workload requirement module 215 selects the next query class (step 540) and repeats step 520 through step 535 for each of the query classes. The workload requirement module 215 aggregates the projected new resource requirements determined for each class (step 545) to determine the total unbalanced resource requirements for the entire online/production workload for each unit of performance such as processor power, throughput rate, and I/O per second (further referenced herein as IOPS).

The workload requirement module 215 balances the projected online/production workload (step 550). A certain balance ratio, o, is to be maintained between the processing power and the throughput rate (MB/second). The projected online/production workload is balanced, if required, to ensure that an appropriate amount of processing power is available to drive the I/O requirements.

A typical value of o for business intelligence workloads, based on industry benchmarks and well-studied business intelligence applications, typically ranges between 5 and 10. However, the value for o is highly dependent on the type of workload. If the workload is known to be fairly computationally intensive, the workload requirement module 215 maintains a higher balance ratio for the projected online/production workload. For other workloads, the workload requirement module 215 maintains a lower balance ratio for the projected online/production workload. The system also allows the user to customize the value to be used for o. If the workload requirement module 215 determines that the value calculated for o is not within the appropriate range, a balancing of resource units is required. The workload requirement module 215 adjusts the projected processing power by multiplying the aggregated processing power determined in step 545 by the balance ratio, o. Other projected performance units such as the projected throughput and projected IOPS are set equal to the aggregated values determined in step 545.

The workload requirement module 215 determines whether to perform analysis of the batch/ETL workload (decision step 555). A batch/ETL workload typically comprises an extract phase, a transform phase, and a load phase. The extract phase retrieves all the necessary information from production and external data sources. The extracted data is then passed on to the transform phase. The transform phase ensures that the extracted data is in an appropriate format, missing values are provided, values are consistent, and values are normalized if required. The load phase takes the transformed data and inserts it into the data warehouse.

The workload requirement module 215 utilizes any known or available technique for developing an initial sizing for batch/ETL. An exemplary method for developing an initial sizing for a batch/ETL workload is described. The workload requirement module 215 determines the resource requirements for the extract phase and the transform phase (step 560). The workload requirement module 215 determines the resource requirements for the load phase (step 565). The workload requirement module 215 determines the workload sizing requirements for the batch/ETL workload (step 570) by selecting the higher workload requirement between the combined extract phase and the transform phase compared to the load phase.

To determine the resource requirements of a batch/ETL workload, the workload requirement module 215 calculates the number of rows that are transformed and loaded. The workload requirement module 215 calculates the processing power per second rate as well as the total number of megabytes and I/Os processed in the extract-transform phase and the load phase. Using these calculations, the workload requirement module 215 is able to determine a time window required by the extract-transform phase and the load phase. The workload requirement module 215 can then arrive at the number of processing power units, megabytes per second throughput rate, and I/Os per second required.

The workload requirement module 215 makes several simplifying assumptions to generalize the determination of the batch/ETL workload requirements. For instance, the use of averages (i.e., secondary indexes per table, row input/output sizes, etc.) and hardware/DBMS/workload-specific variables (i.e., physical write performance penalty, transform complexity, etc.) make the approach simple to use provided the required variable measurements can be obtained. The workload requirement module 215 documents any assumptions made during the workload determination process (step 575).

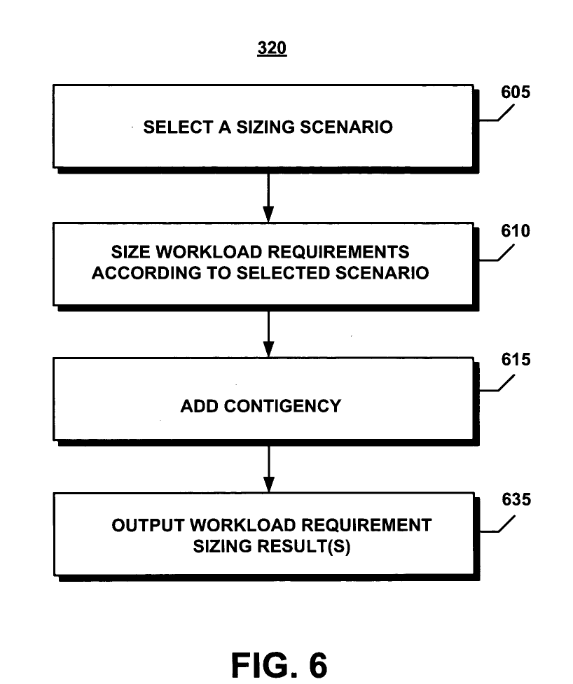

FIG. 6 illustrates in more detail a method of the workload selection module 220 in performing step 320, “size workload requirement according to one or more selected scenarios”. The workload selection module 220 selects a sizing scenario (step 605). The sizing scenario comprises considering the online/production workload, the batch/ETL workload, or a workload comprising the online/production workload and the batch/ETL workload operating concurrently.

The workload selection module 220 sizes workload requirements according to the selected scenario (step 610). If the application to be sized has only an online/production workload, then the resource requirement is based on the demands of the online/production workload. Similarly, if it is known that the batch/ETL workload is more demanding than the online/production workload, the resources required are based strictly on the demands of the batch/ETL workload.

If the workload comprises the online/production workload and the batch/ETL workload operating concurrently, then the workload selection module 220 selects an aggregate of resource demands from the online/production workload and the batch/ETL workload for sizing. In the case that the online/production and batch/ETL workload do not run concurrently, the maximum of the resources determined for the batch/ETL workload and the online/production workload are used for sizing. Once the appropriate resource demands have been determined, the workload selection module 220 adds contingency to the workload requirements. The contingency value is adjustable according to customer requirements, accommodation for periodic spikes in workload, and accommodation for growth in the business intelligence system.

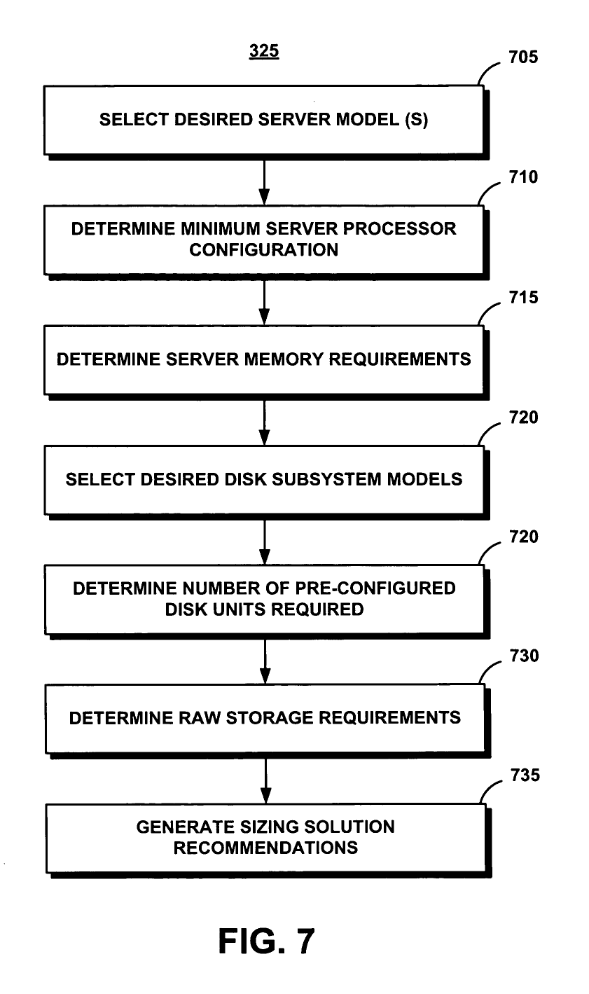

FIG. 7 illustrates in more detail a method of the hardware configuration module 225 in performing step 325, determine hardware configuration. The hardware configuration module 225 selects hardware configurations meeting the workload requirements determined in step 320 as well as other functional requirements. The hardware configuration module 225 comprises a database containing information about current server models and disk subsystems. For each server model, the database comprises information about server form-factor (i.e., rack-mounted versus desk side), different processor configurations, ratings of applicable configurations in terms of, for example, a minimum and maximum amount of memory supported (cache included), number of adapter slots available, network interfaces supported, and other relevant information.

For each disk subsystem, the hardware configuration module 225 assumes a pre-configured unit with benchmarked performance measurements. This pre-configured unit comprises a pre-determined number/size/layout of disk drives, number of disk drawers, number of adapters, and network connections used. The hardware configuration module 225 further assumes that functional information about each unit is available, such as, for example, the number of disk drawers supported, networking technologies supported, the maximum cache size, the RAID levels supported, and other relevant features.

The hardware configuration module 225 selects one or more desired server models (step 705). The hardware configuration module 225 determines, for each selected server model, the minimum processor configuration needed to meet the processing requirement of the workload (step 710). Starting from a cluster size of one, processors are incrementally added to a server node until the required number of processing units (SPECint2000) is met or until no more processors can be added. If more power is required, the cluster size is increased, in single increments, and processors are allocated in the same increments to each node in the cluster. The process is repeatedly carried out until the required number of processing units has been obtained for each selected server model, generating a list of minimum server configurations for each selected server model.

The hardware configuration module 225 determines the amount of random access memory (RAM) required for the minimum server configuration for each selected server model (step 715). The amount of RAM is determined based on informal industry guidelines that consider the number of processors per node, memory requirements of the operating system and DBMS, number of connections to the DBMS, and memory required by other components.

The hardware configuration module 225 selects desired disk subsystem models (step 720). The hardware configuration module 225 determines, for each selected model, the number of pre-configured units required (step 725) by dividing the final calculated throughput ratio of the workload by the peak throughput rate supported by the pre-configured unit. This calculation inherently assumes that the exact pre-configured unit is used in the system being sized. It also assumes that the calculated number of pre-configured units are capable of achieving the calculated IOPS performance requirement of the workload.

The hardware configuration module 225 determines raw storage requirements for the system (step 730). The pre-configured disk unit may need configuration changes to achieve the raw storage space required. Reconfiguring typically involves adding more disks, controllers, disk drawers, and potentially additional pre-configured units. The amount of total storage space required is determined using informal industry guidelines based on the raw data size, the requirements of the operating system, DBMS, application, and other programs, the space required for staging tables in the batch/ETL workload, and additional space for system growth.

Once a list of server and disk subsystem configurations have been produced, the hardware configuration module 225 generates a list of sizing recommendations comprising a recommended server configuration and disk subsystem configuration required (step 735). The hardware configuration module 225 uses a compatibility matrix to determine which models of servers support which models of disk subsystems.

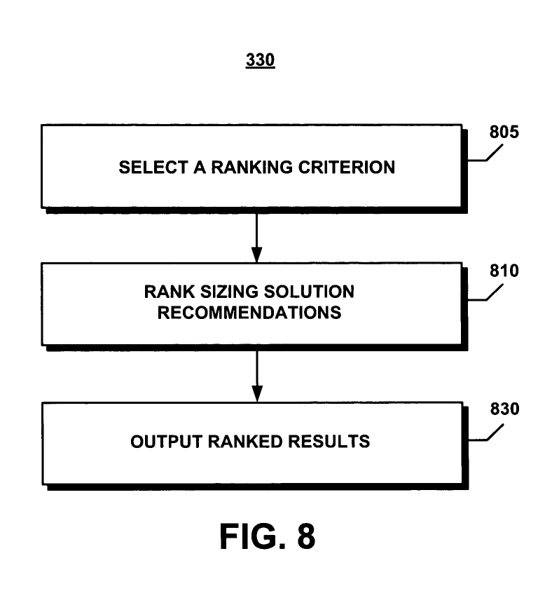

Once complete-system solutions have been determined, they can be presented to the user according to a ranking criterion. FIG. 8 illustrates in more detail a method of the ranking module 230 in performing step 330, “ranking configurations”. A user selects a ranking criterion (step 805), such as how closely the system meets the required resource requirements, system price, price per performance, availability, upgradeability, etc.

The ranking module 230 ranks the sizing solution recommendations produced by the hardware configuration module 225 according to the selected ranking criterion (step 810). The ranking module 230 outputs the ranked results to the user (step 830).

It is to be understood that the specific embodiments of the invention that have been described are merely illustrative of certain applications of the principle of the present invention. Numerous modifications may be made to the system, method, and service for automatically determining an initial sizing of a database system running a business intelligence workload described herein without departing from the spirit and scope of the present invention. Moreover, while the present invention is described for illustration purpose only in relation to users connected through a network, it should be clear that the invention is applicable as well to, for example, to local users.

What is claimed is:

1. A method for automatically determining an initial sizing of a database system, comprising:
inputting collected data;
automatically calculating workload resource requirements for the database system, based on the collected data;
selecting a desired combination of workloads, based on the characteristics of a customer's environment;
automatically determining available hardware configurations based on the selected combination of workloads; and
presenting the available hardware configurations that meet the calculated workload resource requirements.

2. The method according to claim 1, further comprising automatically ranking the available hardware configurations by desired criteria; and
wherein presenting the available hardware configurations comprises presenting the ranked hardware configurations.

3. The method according to claim 1, wherein automatically determining the workload resource requirements comprises projecting the new workload resource requirements based on the analysis of comparable workload models.

4. The method according to claim 1, wherein selecting the desired combination of workloads comprises independently sizing an extract-transform-load (ETL) workload.

5. The method according to claim 1, wherein selecting the desired combination of workloads further comprises independently sizing a query workload.

6. The method according to claim 1, wherein automatically determining available hardware configurations comprises sizing a user-determined combination of an extract-transform-load (ETL) workload and a query workload.

7. The method according to claim 1, wherein automatically determining the workload resource requirements for the database system comprises expressing the workload resource requirements in terms of hardware-independent parameters.

8. The method according to claim 1, wherein automatically determining the available hardware configurations comprises automatically identifying the available hardware configurations that meet the workload resource requirements.

9. The method according to claim 5, wherein sizing the query workload comprises selecting a representative query, Q_{A}, for each workload class C to use as a basis for sizing class C in the new query workload.

10. The method according to claim 9, further comprising converting processing units for the representative query, Q_{A}, chosen from each workload class, from processor utilization to SPECint2000 units.

11. The method according to claim 10, further comprising projecting new resource requirements for the representative query, Q_{A}.

12. The method according to claim 11, further comprising determining a total resource requirements for the workload class, C.

13. The method according to claim 12, further comprising aggregating the total resource requirements for each workload class, Cᵢ, of the workload.

14. The method according to claim 13, further comprising balancing the aggregated requirements.

15. The method according to claim 14, wherein balancing the aggregated requirements comprises ensuring an acceptable balance ratio between processor units and disk (I/O) units is achieved for the workload.

16. The method according to claim 15, further comprises if the balance ratio is not within an acceptable range, adjusting the parameters such that the balance ratio is within an acceptable balance range.

17. The method according to claim 1, wherein presenting the available hardware configurations for selection of the initial sizing comprises a server configuration.

18. The method according to claim 1, wherein presenting the available hardware configurations for selection of the initial sizing comprises a data storage system configuration.

19. The method according to claim 17, wherein sizing the server configuration comprises determining the minimum number of server nodes and processors required for each desired server model.

20. A computer program product having a plurality of executable instruction codes on a medium, for automatically determining an initial sizing of a database system, comprising:
a first set of instruction codes for inputting collected data;
a second set of instruction codes for automatically calculating workload resource requirements for the database system, based on the collected data;
a third set of instruction codes for selecting a desired combination of workloads, based on the characteristics of a customer's environment;
a fourth set of instruction codes for automatically determining relevant hardware configurations based on the selected combination of workloads; and
a fifth set of instruction codes for presenting the available hardware configurations that meet the calculated workload resource requirements.

21. A system for automatically determining an initial sizing of a database system, comprising:
an input collection module for inputting collected data;
a workload requirement module for automatically calculating workload resource requirements for the database system, based on the collected data;
a workload selection module for selecting a desired combination of workloads, based on the characteristics of a customer's environment;
a hardware configuration module for automatically determining relevant hardware configurations based on the selected combination of workloads; and
a ranking module for presenting the hardware configurations that meet the calculated workload resource requirements.

22. A service method for automatically determining an initial sizing of a database system, comprising:
inputting a set of data for defining a workload of the database system;
invoking a hardware sizing system, wherein the input set of data is made available to the hardware sizing system; and
receiving a set of available hardware configurations from the hardware sizing system, wherein the set of hardware configurations satisfies a calculated workload resource requirement for the workload of the new database system while satisfying other functional and desirable requirements of the new system.
